(19) United States
(12) Patent Application Publication
(10) Pub. No.: US 2004/0209232 A1
(43) Pub. Date: Oct. 21, 2004

(54) Method and system for selective prenatal and postnatal learning

(76) Inventors: Dolores Neumann, New York, NY (US); Melissa Neumann, New York, NY (US)

Correspondence Address: Junrui Yang, 6815 Devon Way, San Jose, CA, 95129, US

(21) Appl. No.: 10/419,079

(22) Filed: Apr. 21, 2003

(51) Int. Cl. G09B 19/00

(52) U.S. Cl. 434/236

(57) ABSTRACT

A method and a system which facilitates the development, administration and management of a plurality of sensory projectors which are part of a prenatal-postnatal learning curriculum including automated and manually administered learning exercises. Specifically, informational vectors and associated vector generators (for example, sound generators, olfactory generators, visual displays, tactile devices etc.) designed to impart information to particular senses (sight, sound, touch, smell, taste) are managed and coordinated in conjunction with a prenatal-postnatal learning curriculum and associated manually administered exercises. Coordination between the various vector generators, the manually administered exercises and curriculum management may be accomplished using one or more processing devices such as a computer using various storage media (for example, magnetic disks, memory sticks, CD's), communication networks and software.

### BACKGROUND OF THE INVENTION

1. Field of the Invention

The present invention relates to a system and method for prenatal and postnatal learning, and more particularly, to a method and system for tailoring and managing a plurality of learning vectors in conjunction with a prenatal and postnatal learning curriculum.

2. State of the Art

In 1575 the Spanish physician Juan Huarte defined intelligence as the ability to learn, to exercise judgment, and be imaginative. One can extend this definition of intelligence to the ability to organize volumes of information and to reason. Neuroscientists and pediatric behavioral specialist have made numerous discoveries relating to the relationship between measurable intelligence indices and early learning programs. Only relatively recently have studies shown that cognitive processes begin during pregnancy.

In many cases the information vectors (for example, sources of information directed at particular senses) that are applied to early learning do not fully stimulate all of an infant's senses. This is unfortunate since significant amounts of information processing capacity are associated with senses other than sight and hearing. The information capacity (bits) for the various human senses areas follows; sight 3×10⁶ bits, hearing between 2×10⁵ and 5×10⁵ bits (depending on age), tactile/touch sensations 2×10⁵ bits, smell 100 bits and taste 10 bits. The effectiveness of these senses varies from conception to birth and onward in life.

A question which has generated considerable debate in recent years has to do with the appropriate age and method to start a training program for an infant or young child. A reasonable assumption would be that learning can begin when the senses can take in information and that information can be stored or otherwise processed. The first components of the ear appear in the 3^{rd} week of gestation and achieve some functionality by the 16^{th} week. The fetus begins active listening by the 24^{th} week. Ultrasound observations indicate that the fetus hears and responds to a sound pulse starting about 16 weeks of age; this is even before the ear construction is complete. The cochlear structures of the ear appear to function by the 20^{th} week and mature synapses have been found between the 24^{th} and 28^{th} weeks. It is therefore reasonable to begin a learning regiment during the third trimester. The sense of hearing is probably the most developed of all the senses before birth.

The learning process for infants may be thought of as a building process for intelligence. Each individual has different abilities and the intent of the program is to help the child achieve his or her own full individual potential. According to recent studies by neuroscientists, human Newborns are born both experience expectant and experience dependent. The infant's brain, its structure and biochemistry such as the development of synapses and neurotransmitters, are significantly dependent on the informational stimulation provided by caregivers commencing with infancy and even prior to birth. This translates into developing the sensory and cognitive potential of the young child. Nature and nurture are directly dependent on one another. The proposed program recognizes the vitalness of stimulation and information both in the latter trimester prenatally as well as postnatally. In order for head start to be most effective it should commence at this early stage of development, namely infancy and pre-birth. There are specific windows of opportunities for infants and young children to develop synapses as well as other biochemical structures necessary for the learning process. Neuroscientists have discovered that the synapses related to the learning process are first developed within approximately the first two and a half years of life commencing prior to birth.

The various components that go into building the intelligence of an infant come from different sources which are then connected. It begins with a foundation which starts in the womb using auditory and tactile senses and then continues after birth using all the sense. Each volume of information provides a foundation for the next level. In fact research from the University of California in Irvine has provided some information about the possible effect relating to the intelligence of children who were exposed to Mozart at an early age.

A coordinated educational curriculum started at an early age can enhance the ability of a child to learn in later years; see Appendix A entitled “The First Three Years”, authored by the present inventors, incorporated herein by reference.

What is needed is a method and system for selectively configuring, administering and managing information vectors which are part of a curriculum tailored to the environment of an infant, the infants sensory development state and the demonstrated abilities of the infant exposed to this curriculum.

### SUMMARY OF THE INVENTION

An object of the present invention is to provide a method and system which facilitates the development, administration and management of a plurality of informational vectors which are part of a prenatal-postnatal learning curriculum including automated and manually administered learning exercises. More specifically, informational vectors and associated vector generators (for example, sound generators, olfactory generators, visual displays, tactile devices etc.) designed to impart information to particular senses (sight, sound, touch, smell, taste) are managed and coordinated in conjunction with a prenatal and postnatal learning curriculum. Coordination between the various vector generators (also referred to as sensory projectors herein) and curriculum management may be accomplished using one or more processing devices such as a computer using various storage media (for example, magnetic disks, memory sticks, CD's), communication networks and software. Additionally, responses from a learning subject of a given age (for example, the third trimester of pregnancy up to the age of a toddler) may be monitored, recorded and used to modify or enhance the learning curriculum.

According to the present invention, information vectors are introduced into a subject's (for example, a fetus, infant or toddler) environment. The information vectors target the various senses (hearing, sight, sound, touch, smell) in a coordinated fashion in conjunction with a prenatal and postnatal learning curriculum (also referred to as learning curriculum herein). The information vectors may also be modified in accordance with the sensory development of the subject and any feedback relating to the subject's interaction with previous related exercises. Additionally, the information vectors may be utilized to re-enforce manually administered exercises.

The various information vectors are generated by vector generators which may receive programming instructions which configure the information vectors associated with controlled vector generators in accordance with a learning curriculum, the sensory development of the subject, input from the curriculum administrator (for example, the Parents) and feedback from the subject. The programming instructions received by vector generators may be received via magnetic media, through a network or by some similar means. The activity of the various vector generators may be controlled and coordinated by a central processing system (for example, a personal computer) which facilitates administration and modification of a learning curriculum. The vector generators may provide feedback and record information to the central processing system relating to previously administered information vectors and subject activity. Based on recorded information, subject feedback and input from the curriculum administrator the learning curriculum may be modified to suit the learning subject's needs. Additionally, the recorded information and feedback may be used to generate progress reports which may be transmitted to interested third parties (for example, Grand Parents) or incorporated into memorabilia (for example, a Baby Journal).

The prenatal and postnatal learning curriculum can begin around the third trimester of pregnancy. This phase will focus on the subject's sense of hearing. The complexity of the auditory information vectors during this period are geared to the capabilities and limitations of the developing cochlear structures of the ear and associated synapses. Initially simple sounds and auditory constructs are used. These simple sounds can be associated with more complex symbols as the administration of the learning curriculum program progresses. Simple rhythmic sequences introduce mathematics to the prenatal subject. As the program continues more complex sounds can be more specifically chosen involving music, language, language syntax, environmental sounds and the like (for example, animal sounds, weather sounds, household sounds etc.).

The sound relationships developed during the third trimester can be used in conjunction with information vectors associated with other senses in the postnatal period. For example, the sound of a dog barking experienced in the womb may be associated with images of a dog, which are presented after birth. Prenatally, three taps synchronized with the auditory projection (for example, a vocalized phrase) “one, two, three” may be associated with the symbols 1, 2, and 3 after birth. The records maintained on a central processing system may be used to track, modify and enhance linkages between the various information vectors.

Software resident on the central processing system may layout an entire prenatal and postnatal learning curriculum with control instructions for a plurality of vector generators (audio devices, visual display devices, sprayers for spraying scents, tactile devices etc.). This learning curriculum could take advantage of proven methodologies, strategies and linkages. Additionally, this learning curriculum can be augmented by information specific to the learning subject (for example, sonogram information, responsiveness to particular information vectors etc.), input from the curriculum administrators (for example, the Parents) and feedback from the subject (for example, a fetus around the third trimester, an infant or a toddler).

Language is an integral part of any formal curriculum and the language elements, constructs and the like that are selected may be directly related, coordinated and synchronized with events associated with the various senses (visual images, sounds, motions, smells etc.). In accordance with an embodiment of the present invention, single words are related to one or more images, sounds, tactile events and/or smells, after which phrases and sentences are built in a like fashion. For example, nouns, verbs, adjectives, and prepositions are presented separately over time and then woven together first in small groups of words then phrases (the word “the” being introduced or “this is a” introduced) and finally the more complex sentence structure, which also includes question and answer on the part of the curriculum administrator. Included with the language exercises are the visual symbols of the letters with their names, which can be presented within the first month. Phonetics without visuals are also presented in the first month. Short and long vowel sounds are followed by the presentation of the consonants, diphthongs (for example, “th”, “ch”, and “sh” sound) and the like.

A prenatal and postnatal curriculum may reinforce or be reinforced by manually administered exercises. An example of such a manually executed exercise is as follows:

Math Exercise

This exercise starts to introduce the subject of mathematics, and in particular geometrical concepts and constructs. Take a circle, a square, and a triangle. Due to the fact that these exercises are both visual and linguistic (also referred to as auditory herein), language elements and syntax are also introduced to the learning subject and directly coordinated with a visual image minimizing any confusion with any other visual image. Additionally, circles having various colors are utilized. However, the word ‘circle’ refers to the attribute of the shape at this point and linked to the property of the curve of the circle rather than to the attribute of color. This is done by synchronizing, for example, the word “circle” when presenting a circle. This illustrative example assumes the subject is a newborn infant.

Exercise 1—Circle, Triangle, Square

a. Present an image of a circle to the subject in conjunction with an audible projection of the word, “Circle.” Three variations: 1) a colored circle 2) a white frame around a colored circle 3) a white frame with just the outline of the circle in black. Language is the combination of the visual and the aural. At first one simple word is specifically and consistently chosen, synchronized and linked with a visual image.

b. Remove the circle from the subject's line of vision. Place the circle again in the subject's line of vision and initiate an audible projection of the word, “Circle.”

c. Similar to a. except with a colored or black triangle.

d. Remove the triangle for a few moments for contrast. Then, present the triangle once again for the subject to observe and initiate an audible projection of the word, “Triangle.”

e. Similar to a and c, except with a colored or black square.

f. Remove the square for a few moments for contrast. Then, hold the square once again for the subject to observe and say, “Square.”

Exercise 2—Circles, Triangles, Squares

Now utilize two objects to introduce the subject to quantity.

a. Present an image of two identical circles, such as two black circles, to the subject and initiate an audible projection of the word, “Circles.” the word, “Circles” emphasizing the plural. Then audibly project, “two circles.”

b. Remove the circles from the subject's line of vision. Place the circles again in front of the subject and initiate the audible projection of the word, “Two circles.” Note: use of the words “two circles” instead of “circles” are presented in the second week to a learning subject. Then repeat, contrast with one circle.

c. Take two triangles and presenting the triangles in the subject's line of vision, initiate an audible projection of the words, “triangles.” Again, as a variation similar to the circles, introduce the term “two triangles” in the second week to the learning subject.

d. Remove the triangles for a few moments for contrast. Then, present the triangles once again for the subject to observe and initiate an audible projection of the word, “Triangles.”

e. Take the two squares and holding the squares in the subject's line of vision, initiate an audible projection of the word, “Squares.”

f. Remove the squares for a few moments for contrast. Present the squares once again for the subject to observe and initiate an audible projection of the word, “Squares.”

These exercises, converted into information vectors under the control of a central processing system, would give the administrator control over the type, illumination, timing, repetition and color scheme of element(s) displayed, the characteristics of the voice used to describe the element(s) and coordination with the activities of other vector generators. Elements could be printed out on a color printer or displayed on a display device (for example, a display screen). Additionally, the events and the responses can be recorded, saved as required. Output from these records could be sent to interested third parties (for example, relatives, educators etc.) and added to items of memorabilia (for example, a baby book or educational records).

The present invention can be implemented in numerous forms. Different implementations of the present invention yield one or more of the following advantages. One advantage of the invention is that the learning subject is exposed to a structured prenatal and postnatal learning curriculum at an early stage. Coordinated information streams are provided to multiple senses thereby maximizing information intake. Linkages between sensory events are provided and reinforced over a period of time. Another advantage of the present invention is that individuals with limited experience in infant education can provide a structured learning environment for their child. Still another advantage of the present invention is that information relating to curriculum administration and learning subject feedback/participation may be stored and/or output to custom formats (for example, baby books, progress reports etc.). Yet another advantage of the present invention is that learning events for multiple learning subjects can be implemented.

The foregoing and other objects, features and advantages of the invention will become more apparent from the following detailed description of embodiments, which proceeds with reference to the accompanying drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of a prenatal and postnatal learning system which may be used to implement the method and system embodying the invention;

FIG. 2 illustrates a representative in-utero auditory projection device which may be used in conjunction with an embodiment of the present invention;

FIG. 3 illustrates a representative multifunction sensory stimulation unit which may be used in conjunction with an embodiment of the present invention;

FIG. 4A through 4D illustrates a representative series of display cells which may be used in conjunction with an embodiment of the present invention;

FIG. 4E illustrates a representative display cell holder and control module which may be used in conjunction with an embodiment of the present invention;

FIGS. 5A and 5B illustrate representative computer user interfaces which may be used by a curriculum administrator to input, access and manage information associated with a prenatal and postnatal learning curriculum in accordance with an embodiment of the present invention;

FIG. 6 is flow diagram of the process associated with a learning session associated with a prenatal/postnatal learning curriculum in accordance with an embodiment of the present invention;

FIG. 7 is a flow diagram of the process associated with a sample learning session linking audible, visual and olfactory sensory events in accordance with an embodiment of the present invention;

FIG. 8 is a flow diagram of the process associated with device and information management in accordance with an embodiment of the present invention.

### DETAILED DESCRIPTION OF THE INVENTION

The invention pertains to a method and a system which facilitates the development, administration and management of a plurality of informational vectors which are part of a prenatal-postnatal learning curriculum including automated and manually administered learning exercises. Specifically, informational vectors and associated vector generators (for example, sound generators, olfactory generators, visual displays, tactile devices etc.) designed to impart information to particular senses (sight, sound, touch, smell, taste) are managed and coordinated in conjunction with a prenatal-postnatal learning curriculum and associated manually administered exercises. Coordination between the various vector generators and curriculum management may be accomplished using one or more processing devices such as a computer using various storage media (for example, magnetic disks, memory sticks, CD's), communication networks and software.

According to an embodiment of the present invention, a central processing system, also referred to as a control center herein, coordinates the activity of a plurality of remote vector information generators in conjunction with the administration of a prenatal-postnatal learning curriculum and associated manually administered learning exercises. Information is transferred between the central processing unit and the plurality of vector information generators (also referred to as sensory projectors or sensory projector devices herein) by storage media (for example, magnetic media, CDROM, memory sticks, etc.) and/or communication networks (for example, Local Area Network, wireless networks). The sensory projectors include, but are not limited to, an in-utero audio projection device and postnatal devices that generate information vectors targeted at one or more of the senses (for example, hearing, sight, smell, tactile etc.). Additionally, customized directives for the curriculum administrator can be generated (for example, printed out or displayed) to accompany various curriculum exercises.

The control center, comprised of hardware and software, facilitates the management and administration of a prenatal-postnatal learning curriculum and an associated manually administered learning program. The control center includes user interfaces associated with, accessing and managing prenatal-postnatal learning curriculum, programming and managing the plurality of remote learning vector generators, managing collected data and generating reports associated with the curriculum and collected data.

The detailed description of the invention includes methodology, procedures, steps, logic blocks, processing, and other symbolic representations of data processing devices coupled to networks. The appearances of the phrase “an embodiment” in various places in the specification is not necessarily referring to the same embodiment, nor are separate or alternative embodiments mutually exclusive of other embodiments. Further, the order of blocks in process flowcharts or diagrams, representing one or more embodiments of the invention, do not inherently indicate any particular order nor imply any limitations in the invention. However, there are prerequisite introductions to the vectors which are then built upon as illustrated in Exercise 1 of the text previously mentioned. A Newborn might need more well defined language cues related to images, for example, than an older child who is already familiar with the language of a specific image or action.

Central Processing Systems also referred to as control centers herein, include but are not limited to personal computers, laptop computers, computer terminals, personal digital assistants, palm-sized computing devices, smart phones and computer work stations. Networks include but are not limited to wired and wireless communication networks.

Sensory projectors, also referred to as information projectors herein, include but are not limited to audio sensory projectors, visual sensory projectors, olfactory sensory projectors and tactile sensory projectors. Tactile sensory projectors include, but not limited to, one or more selectively movable elements (for example, one or more selectable fabric types).

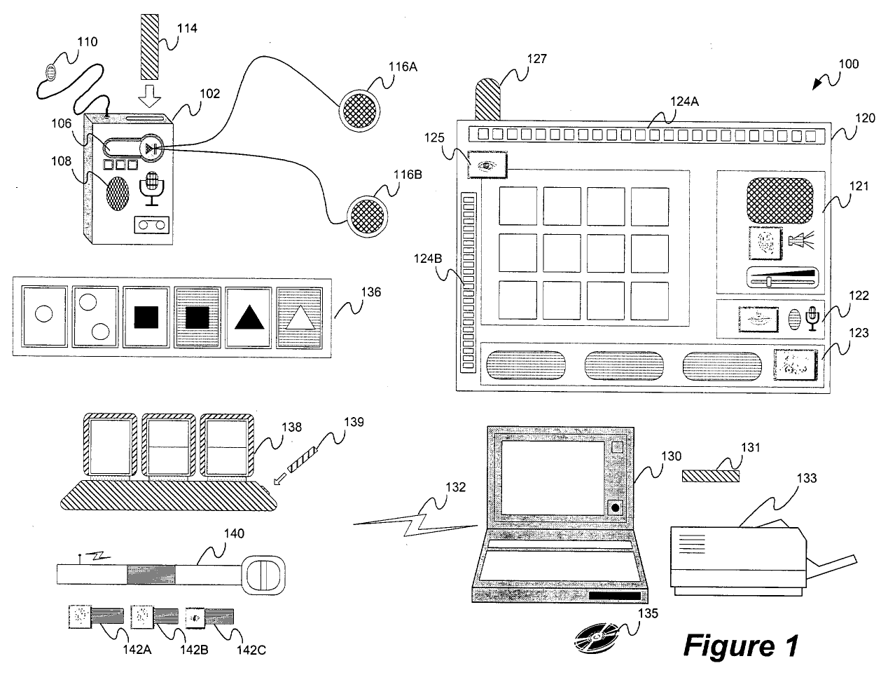

FIG. 1 shows an exemplary system configuration in which the present invention may be implemented in accordance with the embodiments of the present invention. Prenatal-postnatal learning system 100 includes, but is not limited to, one or more sensory projectors (prenatal audio projector 102, multiple sense sensory projector 120, portable cell holder and control module 138 and a wearable sensory projector 140), a central control system 130 (for example, a laptop computer), storage media (HDD, memory sticks 114, 127, 131 and CDROM 135), a color printer 133 and a communications network 132.

Software resident on central control system 130 includes, but is not limited to, a sensory projector control module, a curriculum management module and one or more predefined learning curriculum modules. The sensory projector control module manages the control instructions for the plurality of sensory projection devices and color printer 133. The curriculum management module manages the one or more predefined learning curriculum modules, generates control instructions for the plurality of sensory projection devices, manages stored records, generates output reports, supplemental material (for example, flash cards 136) and links related files (for example, movies of a training session). The one or more predefined curriculum modules include pre-defined learning curriculums and supplemental material. Communication between the central control system and plurality of sensory projection devices may be by stored media (for example, a memory stick, CDROM etc.) or a communications network (wired or wireless).

Additionally, supporting material and reports may be printed using color printer 133. Printable supporting material includes, but is not limited to, flash cards, transparencies and the like.

Prenatal audio sensory projector 102 includes, but is not limited to, a control panel 106, a microphone 108, ear phone 110, storage means 114 (for example, a memory stick) and in-utero speakers 116A and 117B. Earphone 110 can be used by the administrator (for example, the subject's mother) to lesson to the information vectors the subject (for example, a fetus) is being exposed to. Additionally, the information vectors may be modified so as to adjust for sound attenuation caused by the amniotic fluid and the estimated development of the fetal auditory system.

An illustrative third trimester exercise including rhythmic sequences and the sentence “one and two and three and four” is provided below. The words that are underlined should be synchronized with audible events.

(Audible projections of the underlined words should be framed by various related sensory events.)

a) 1) one and two and three and four and

2) Repeat a1)

3) Repeat a1)

4) Repeat a1)

b) 1) one and two and three and four and

2) Repeat b1)

3) Repeat b1)

4) Repeat b1)

c) 1) one and two and three and four and

2) Repeat c1)

3) Repeat c1)

4) Repeat c1)

These instructions could be communicated to prenatal audio sensory projector 102 via storage media (for example, memory stick 114) or through a communications network (for example, wireless network 132). A user may obtain supplemental information the exercise described above from central control system 130. Additionally, these types of exercises could be used as building blocks for postnatal exercises. The example exercises provided above are provided for purposes of illustration and not limitation.

Multiple sense sensory projector 120 includes, but is not limited to, an audio sensory projector 121, visual sensory projectors 125, 124A and 124B and an olfactory sensory projector (smells) and a microphone 122 for recording responses. Multiple sense sensory projector may also include a video camera (not shown) for recording responses.

Portable cell holder and control module 138 includes, but is not limited to, holders for individually movable cell holders (for example, rotating panels); or static image holding devices with elements for exposing and hiding static image. The individual cells which are housed in the holders may be comprised of flash cards, transparencies, computer displays or polymer dispersed liquid crystals (PDLCs). PDLCs have the particular advantage of being able to have a plurality of images preprogrammed. When an electrical charge is absent from a PDLC, the liquid crystals in a cell are randomly oriented and particular images are displayed when particular voltages are applied.

Wearable sensory projector 140 includes, but is not limited to, detachable sensory projectors 142A, 142B and 142C. These sensory projectors could generate information vectors for various senses (for example, audio, visual, smell etc.).

Central control system 130 can utilize a portable storage means (for example, memory stick 131) or a communications network (for example, wireless network 132) to provision the plurality of sensory projector devices with one or more exercises. Once provisioned, the exercises can be initiated at the subject sensory projector device in accordance with a embodiment of the present invention.

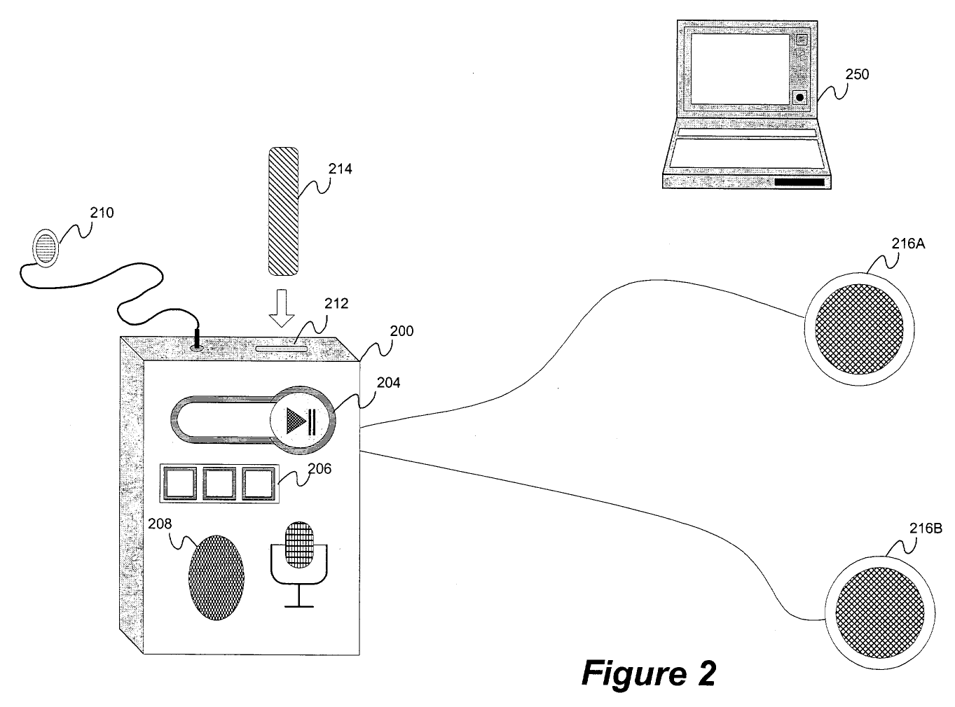

Audio sensory projectors include, but are not limited to, audio player, prenatal audio player and the like. FIG. 2 illustrates a prenatal audio player 200 which may be used in conjunction with an embodiment of the present invention. One or more exercises can be transferred to prenatal audio sensory projector 200 using portable storage media (for example, by inserting memory stick 214 into receiver 212). The exercises may be stored locally or run from the portable storage media. Individual exercises can be selected using control arrays 204 and 206. Microphone 208 can be used by the administrator to interject audible comments and sounds not resident on the stored media. Earphone 210 can be used by the administrator to hear what the subject hears. In-utero audio projectors 216A and 216B can be used to project audio information into the womb. The projections may be adjusted to take into account the audio attenuation of the amniotic fluid and the development of the fetal auditory senses.

The various exercises can be associated logically. For example, individual exercises can include musical and mathematical elements as part of the same exercise. Information pertaining to the subject exercises (for example, amount of information transferred, number of times run, supplemental information added, etc.) may be stored locally on prenatal audio sensory projector 200 and/or on portable storage media 214.

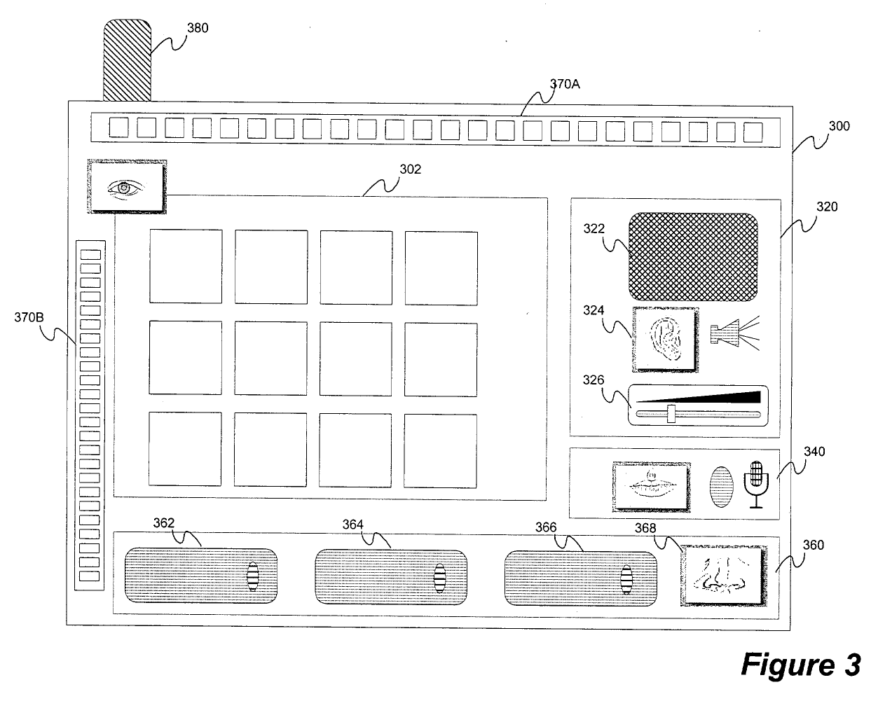

FIG. 3 illustrates multiple sense sensory projector 300 which may be used in conjunction with an embodiment of the present invention. Multiple sense sensory projector 300 includes, but is not limited to, visual sensory projectors 302, 370A and 370B, audible sensory projector 320, microphone 340 and olfactory sensory projector 360.

Visual sensory projector 302, also referred to as display cells or display cell herein, may be comprised of multiple plasma displays, a single plasma display, multiple polymer dispersed liquid crystals (PDLCs) or holders for one or more static elements (for example, flash cards or cut out illustrative diagrams). The display cells may be used to display content for the learning subject or the curriculum administrator. Images (static and animated) may be displayed for the learning subject in conjunction with other sensory activities or as a lone exercise. One or more of the display cells can be utilized to provide administrative information, such as instructions and descriptive information related to the current exercise. For example, information relating to suggestions of collaborative activities could be provided to the curriculum administrator.

Visual sensory projectors 370A and 370B may be comprised of a series of linked illuminating elements (for example, LED's). They may be used to illustrate the special relationships (for example, horizontal, vertical, up, down, left, right etc.). Sensory projectors 37A and 370B may be utilized in concert with other sensory projectors on the same device or on remote linked devices.

Audible sensory projector 320 may be comprised of a speaker unit and associated audio control elements. Microphone 340 may be utilized to record subject responses. Olfactory sensory projector 360 may comprise liquid reservoirs with hold and spray units which can disperse scents (for example, flowery scents). Another example of an olfactory sensory projector comprises one or more impregnated fabrics capable of emitting scents when exposed to a voltage signal. The sensory projectors described in this section may be utilized in concert with other sensory projectors on the same device or on separate devices linked through central processing system.

An exemplary exercise using multiple sense sensory projector 300 is as follows: Visual sensory projector 302 displays a pine tree, audible sensory projector 320 plays the word “tree” and olfactory sensory projector 360 sprays a pint scent. This may be represented as follows:

Tree Exercise—{visual} pine tree, {audio} pine tree, {smell} pine

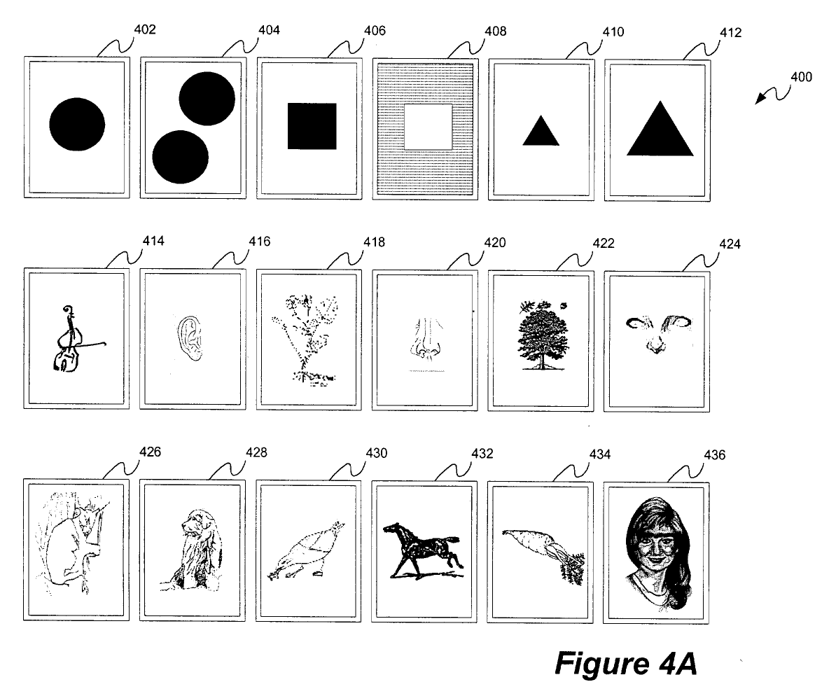

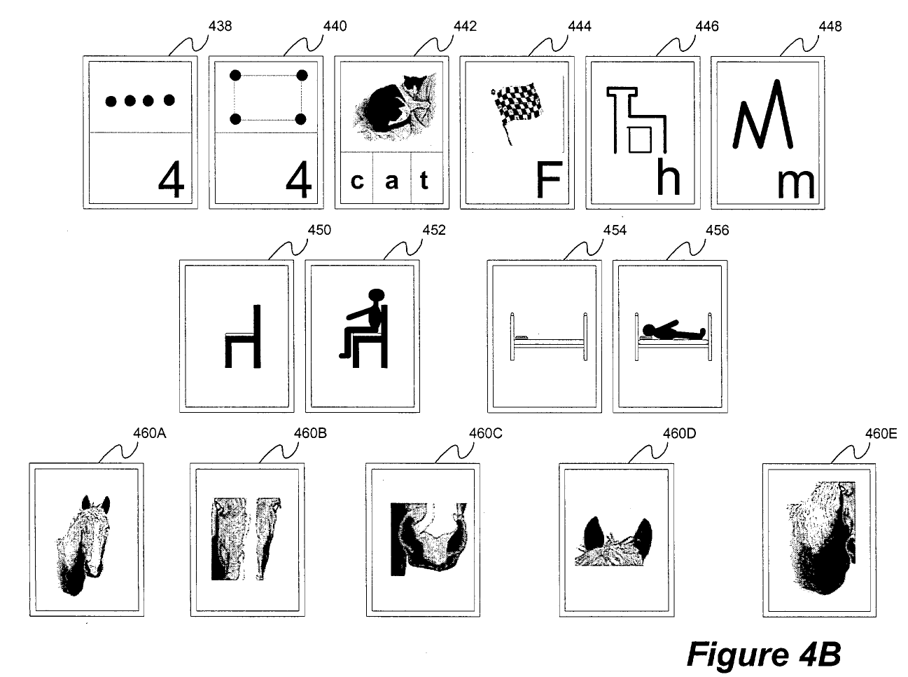

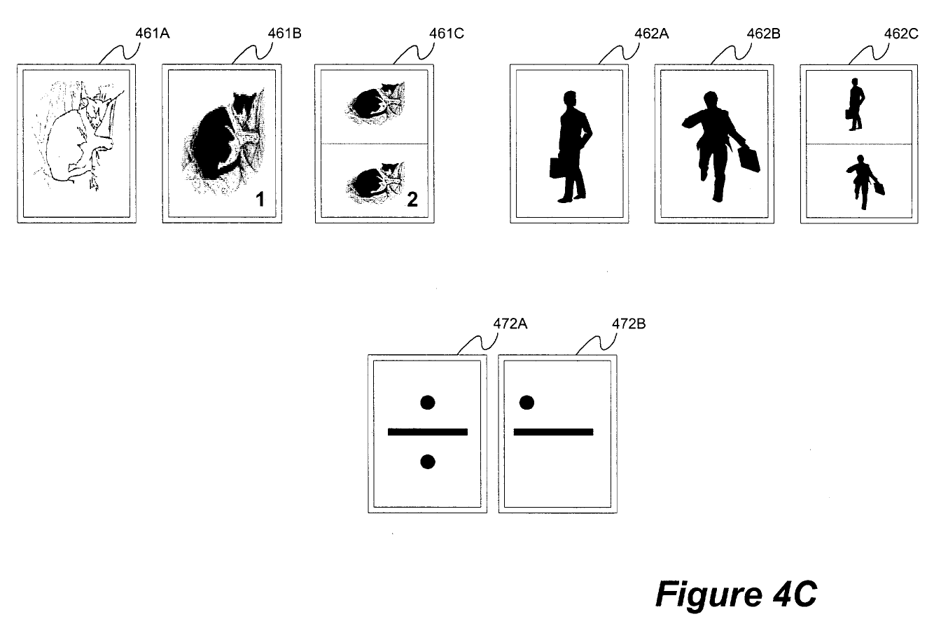

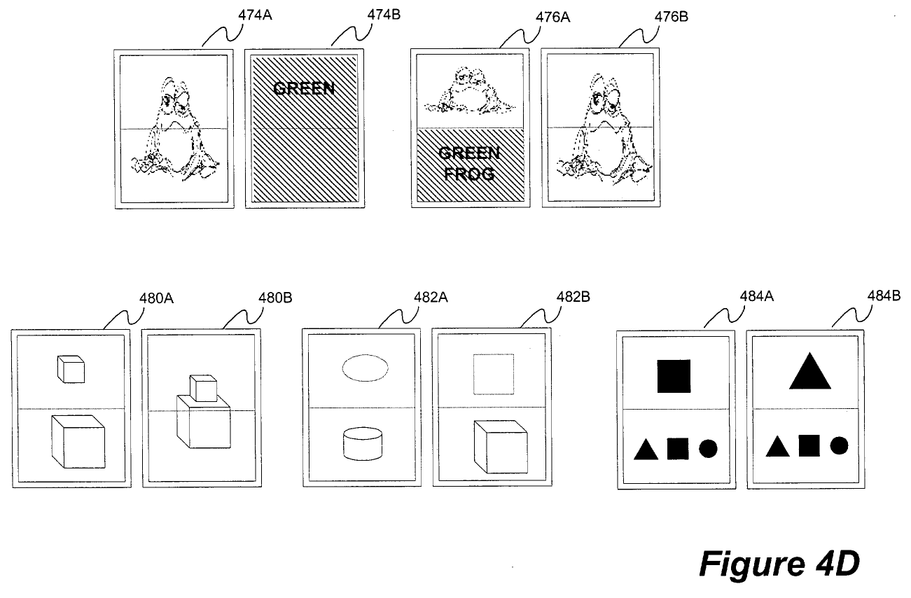

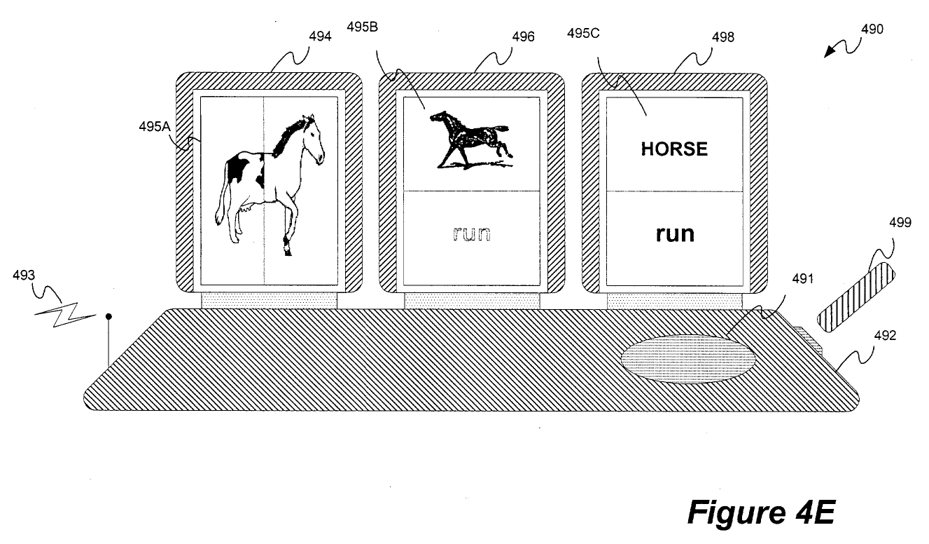

FIGS. 4A through 4D illustrate a plurality of display cells which can be utilized in conjunction with an embodiment of the present invention. The cells presented illustrate relationships between images, sounds, symbols, words, language syntax (for example, nouns, verbs, adjectives, phrases etc.) and spatial relationships (size, left, right, up, down, big, depth etc.). Display cells include, but are not limited to, flash cards, transparencies, computer displays and or polymer dispersed liquid crystals (PDLCs). Display cells may have one or more controllable display regions on the same cell. Cells 402 to 412 illustrate the “shapes” concept. The shapes and their associated parameters (for example, size, orientation, number, background, texture, color, etc.) are illustrated. These shapes when presented together can compose a sequence if presented as circle, square, circle, square, etc. This illustrative exercise introduces mathematical concepts to the learning subject. These parameters may be reinforced with visual and audio components.

An exemplary multiple senses exercise is as follows:

Shape and Number Exercise—

a) {visual} one circle next to one square, {visual} one circle, {visual} one square, {visual} one circle, {visual} one square, {visual, audio} one circle, {visual, audio} one square, {visual, audio}, one circle {visual, audio}, one square, {visual, audio}, one circle {visual, audio}, one square, {visual, audio}.

b) {visual} one oval next to one triangle, {visual} one oval, {visual} one triangle, {visual, audio} one oval, {visual, audio} one triangle, {visual, audio} one oval, {visual, audio} one triangle, {visual, audio} one oval, {visual, audio} one triangle. Repeat procedure a)

c) {visual} two circles next to one square, {visual} two circles, {visual} one square, {visual, audio} two circles, {visual, audio} one square. State, {visual, audio} two circles, {visual, audio} one square, {visual, audio} two circle, {visual, audio} one square, {visual, audio} two circles, {visual, audio} one square.

d) {visual} two triangles next to one oval, {visual} two triangles, {visual} one oval, {visual, audio}, {visual, audio} two triangles, {visual, audio} one oval, {visual, audio} two triangles, {visual, audio} one oval, Repeat procedure c)

Cells 414 through 424 illustrate the relationship between objects, senses and body parts as follows: The relationship between the sound of a violin, an image of a violin 414 and an image of an ear 416. The relationship between the smell of a flower, the image of a flower 418 and the nose 420 is illustrated by this sequence of cells. The linkage between the image of a tree 422, the smell of a tree, and the eyes and the senses used to experience the tree is illustrated in this series of panels.

Cells 426 through 436 illustrate the relationship between creatures/being, images, smells and activities. For example, the subject could be presented with the image of a dog, followed by an animated presentation showing the dog involved in various activities (for example, running, jumping, etc.) and associated audible terms for the dog and its activities.

In accordance with an embodiment of the present invention sensory events of various types can be linked together to generate dynamic exercises which are based partly on the curriculum and partly on exercises which have been presented previously.

Cells 438 through 448 illustrate the relationship between objects, activities, symbols, visual images with language syntax. Cell 438 represents an archetypal illustration where the learning subject first views four circles, which is referred to as “four circles”. The number 4 is hidden at first from the line of sight of the subject. It appears as a separate image and referred to as “number 4”. Finally, the circles and symbol 4 appear in the same frame as the selected words are repeated. In cell 440 four circles are placed in the formation of a square, where the outline of a square may be selectively displayed and hidden, linking arithmetic to geometry. Follow the same procedure as in Cell 438. Cell 442 links a word, its phonemes, and the visual object related to the word (in this case ‘cat’). Cell 442 combines principals introduced earlier. First ‘c’ is introduced, then ‘a’ is introduced, then ‘t’ is introduced. This is combined as ‘cuh ah tuh’ phonetically by an audio information vector. Finally, it is introduced as in Cell 442 where the phonetic word and actual word sound ‘cat’ and then is presented next to the picture of a cat which can be selectively displayed and hidden.

Cell 444 illustrates the relationship between the symbol “F” and a flag. This relationship can be reinforces with information vectors associated with the other senses (for example, audio information vectors). Follow-on exercises can selectively bring in the word “flag” and the various syntactical components of the word. In a similar fashion a relation ship between the letter “h” and a house like structure and the letter “m” and a mountain like structure are illustrated in cells 446 and 448 respectively. In order to remember the phonetic alphabet an image is presented that is closely related to a phonetic sound. The first letter of the word of the image will correspond with the letter presented. Many children learn letters by having the letter look more like a visual object such as “m” for “mountain” (in Cell 448) and comparing letters for contrast (for example, “which letter looks like a mountain”).

Cells 450 through 456 illustrate the relationship between objects, words and activities. Specifically, cells 450 through 456 illustrate the relationship between household objects and activities. In cell 450 a chair is displayed and in cell 452 an individual is shown sitting in the chair. In cell 454 a bed is displayed and in cell 456 an individual is shown sleeping in the bed. Letters, words and symbols associated with the various objects and activities may be selectively presented to the learning subject in a manner so as to reinforce and enhance the relationships.

Cells 460A through 460E illustrate the relationship between part of an object and its constituent components. In this illustrative example cell 460A displays the head of a horse, 460B the face, 460C the nose, 460D the ears and 460E the neck. This type of relationship can be created for similar objects (for example, people, other types of animals etc.) and the various parts between objects can be compared and contrasted.

Referring now to FIG. 4C, cells 461A, 461B and 461C illustrate different representations and utilizations of animate objects. Cell 461A displays the outline of a cat and cell 461B displays a filled in version of a same image of a cat. Cells 461B and 461C illustrate the relationship between animate objects and numbers, where 461C is the actual symbol for the number and may be selectively displayed or presented to another sense (for example, audible). These cells touch on many concepts including: a) the name of the object (vocabulary), b) the cell used quantitatively (math), c) the fact that these two images are the same as opposed to two different images, which is introduced later (same vs. different). Later, subtle differences, such as different types of cats as compared to two identical cats may be introduced. This demonstrates the categorization of images/items. In this example the cat is also knows categorically as an ‘animal’.

Cells 462A through 462C illustrate the relationship between people and activities. These activities may be represented by animate or static content and they may be displayed individually (462A and 462B) or in tandem (462C).

Cells 472A and 472B illustrate complex relationships such as the concept of symmetric and asymmetric. These relationships can be illustrated using multiple sensory projectors.

FIG. 4D illustrates more complex relationships. Cells 474A, 474B 476A and 476B illustrate the relationship between a frog and the color green. These relationships can be illustrated on individual cells (474A and 474B) or using the same surface of a cell. In the latter case or polymer dispersed liquid crystals (PDLCs) can be preprogrammed with multiple display regions which can be selectively turned on or off. Transparencies can have multiple display regions selectively presented using appropriate background lighting. Flash cards with foldable/removable components can also be utilized.

The remaining cells in FIG. 4D illustrate the relationship between 2D and 3D geometric shapes. Cells 480A and 480B illustrate the relationship between size and three dimensional shapes. Cells 482A and 482B illustrate the relationship between 3D and 2D shapes. FIGS. 484A and 484B illustrates the relationship between various two dimensional shapes.

In the example illustrated in FIG. 4E, different aspects of animals are illustrated (for example, the front of end of a horse with the back end of a cow (distinguishing differences), a horse running (nouns and verbs), the word horse, the word ‘run’, different kinds of relationships between animals, numbers, activities etc.). Computer displays and polymer dispersed liquid crystals (PDLCs) can be utilized to display animated events, mix and match discrete entities (for example, a horse and a cow, etc.) and associate symbols (for example, letters, words, phrases, sentences, syntax etc.) and objects. Additionally, one or more of the cells may display information intended for the curriculum administrator such as recommended coordinated activities to be performed by the administrator and/or descriptive information relating to the current exercise or the learning subject.

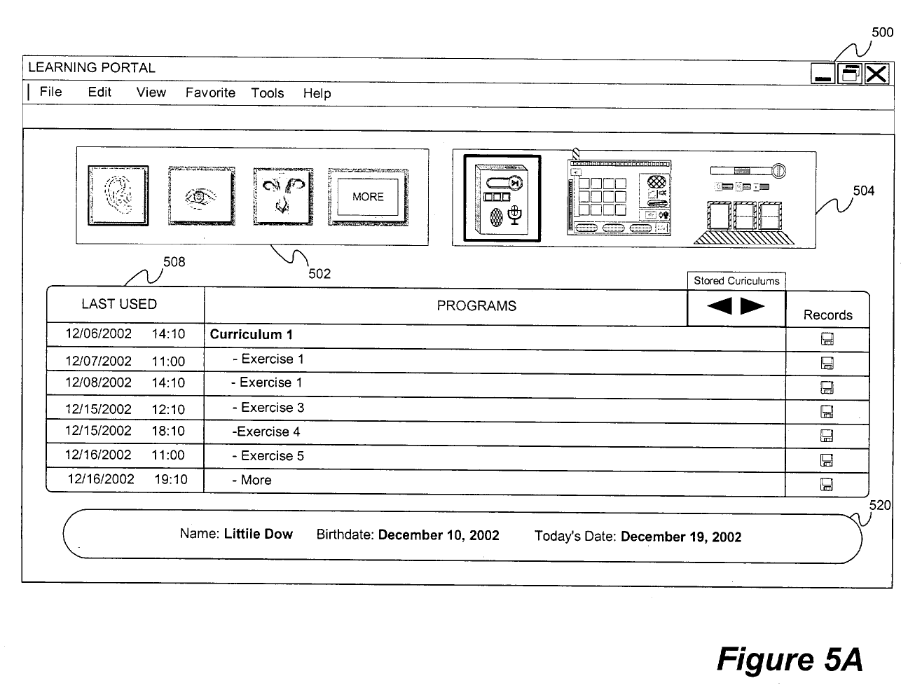

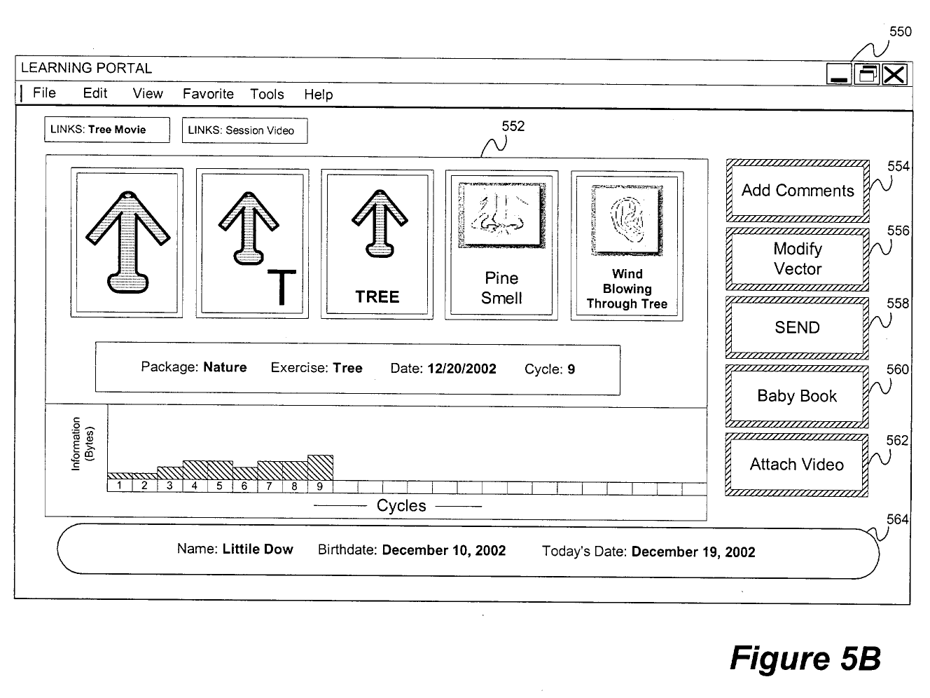

FIGS. 5A and 5B illustrate representative user interfaces which may be used by a curriculum administrator to access and manage sensory projection devices and information associated with a prenatal and postnatal learning curriculum in accordance with an embodiment of the present invention. User interface 500 may be utilized to select different curriculum, exercises, mange sensory projectors and access and manage stored records. Controls in section 502 permit sensory based selections. Controls in section 504 permit sensory projector device based selections. Section 516 controls curriculums, exercises and records. Section 508 displays learning subject related information.

User interface 550 may be utilized to mange stored records. Using this interface, an administrator may recall previously executed learning sessions, generate reports and associate the subject record with other types of stored files (for example, stored movies). Section 552 illustrates an exemplary exercise progress report. Control button 554 provides the ability to add comments to records. Control button 556 provides access to curriculum administration modules. Control button 558 facilitates the transmission of records and reports to third parties. Control button 560 provides access to a “baby book”. Control button 562 facilitates linkages (for example, a software link) between records and stored movies.

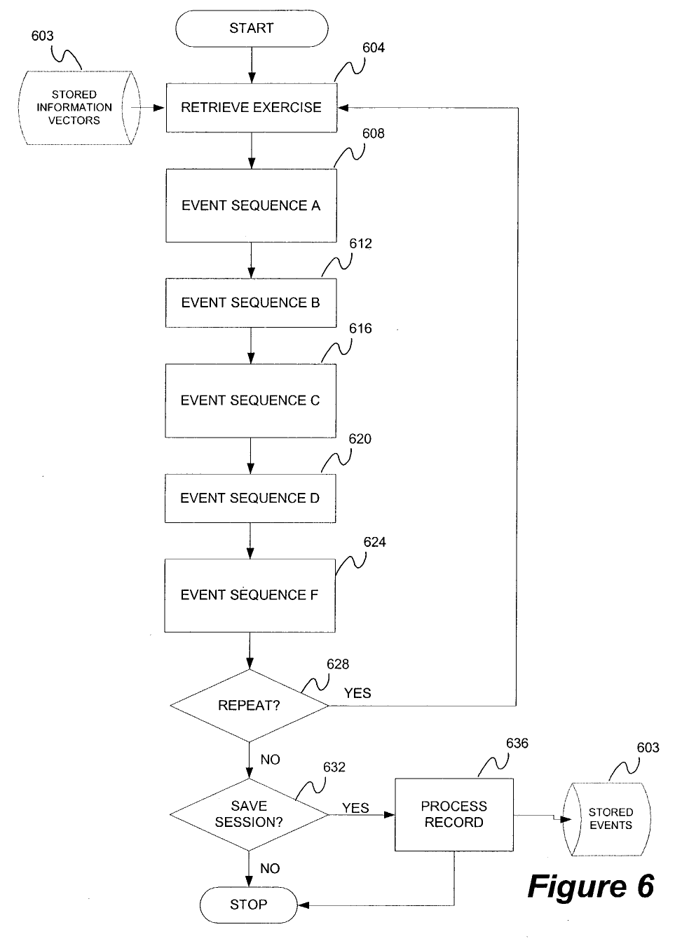

FIG. 6 is a flow diagram of the process 600 associated with a learning exercise associated with a prenatal-postnatal learning curriculum in accordance with an embodiment of the present invention. At 604 an exercise program is retrieved from storage, where the exercise program is comprised of a series of information vectors, also referred to as a series of sequenced events herein. At 608 the first event sequence of a session occurs. At 624 the last event sequence of a session occurs. At 626 a decision is made as to whether to proceed to the next session. If a second session is requested then the process repeats. It is important to note at this point that the second session may be modified to take into account the elements of the previous sessions. When all sessions are complete, a decision is made at 632 as to whether or not to store the session(s) just executed.

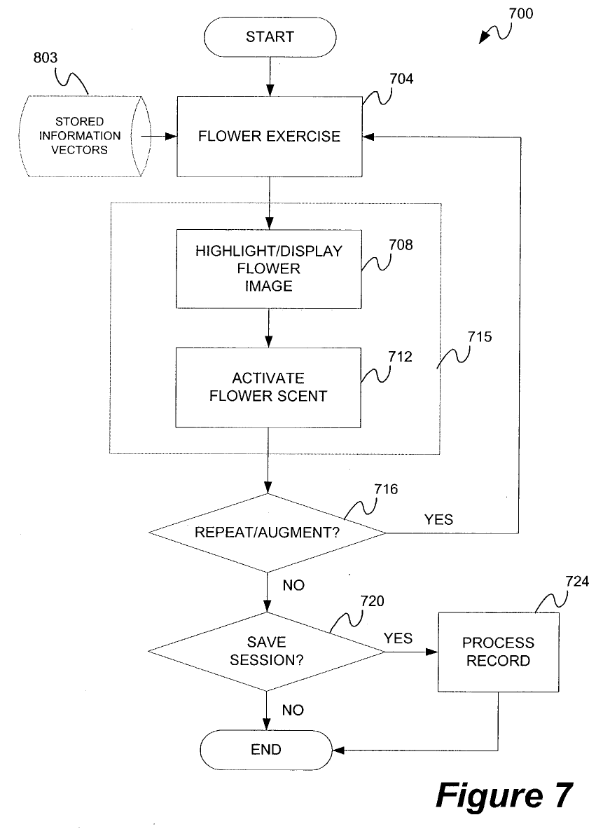

FIG. 7 is a flow diagram of the process 700 associated with a sample learning session linking audible, visual and olfactory sensory events in accordance with an embodiment of the present invention. In this case the process relates to a flower. At 704 the flower exercise stored procedures are accessed. At 708 one or more sensory events are utilized to highlight or draw the subject's attention to the image of a flower (for example, displaying an image of a flower in conjunction with audio elements). At 712 a flowery scent is sprayed into the air. Please note that since the persistence of odors varies with environment it may not be necessary to project new odor with each session. At 716 a decision is made as to whether or not to perform another session and/or augment the next session. When all sessions are complete, a decision is made at 720 as to whether or not to store the session(s) just executed.

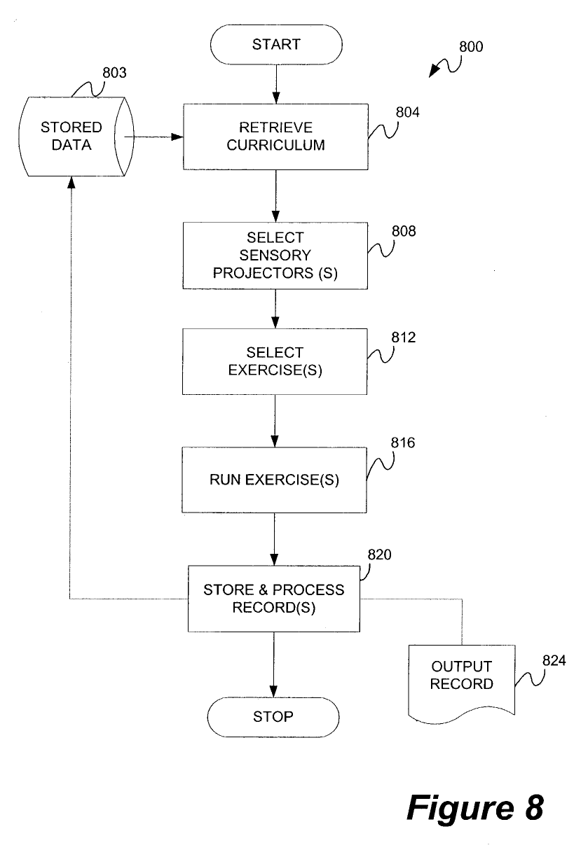

FIG. 8 is a flow diagram of the process 800 associated with device and information management in accordance with an embodiment of the present invention. At 804 a curriculum is selected from one or more stored curriculums. Curriculums provide a plurality of exercises for one or more sensory projectors. At 808 select one or more sensory projectors to be utilized in conjunction with one or more exercises. At 812 select the exercises to be implemented. At 816 run the selected exercises, store the results in storage media 803 and process reports as required at 824.

Different embodiments or implementations may yield one or more of the following advantages. One advantage of the present invention is that the amount of information communicated to the learning subject is maximized by using as many information vectors as possible. Still another advantage of the present invention is that the activities of a plurality of sensory projectors can be coordinated and managed using a central control system.

The many features and advantages of the present invention are apparent from the written description which is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be considered to fall within the scope of the invention.

We claim:

1. A method for implementing a prenatal and postnatal learning program, comprising:
selecting a curriculum from among a plurality of stored curriculums;
selecting one or more sensory projectors from among a plurality of sensory projectors where the sensory projectors support the selected curriculum;
selecting one or more exercises where the selected exercises are included in the selected curriculum and supported by the selected sensory projectors;
implementing the selected exercises; and
storing information relating to the implemented selected exercise.

2. The method as recited in claim 1, where the sensory projectors are selected from among an audio sensory projector, a visual sensory projector, an olfactory sensory projector and a tactile sensory projector.

3. The method as recited in claim 2, where the audio sensory projector is a prenatal audio player or an audio player.

4. The method as recited in claim 2, where the visual sensory projector comprises a visual display screen associated with a microprocessor.

5. The method as recited in claim 2, where in the visual sensory projector includes a display element selected from among a flash card, a transparency, a computer display panel or a polymer dispersed liquid crystal.

6. The method as recited in claim 2, where the visual sensory projector comprises a static image holding device with elements for exposing and hiding static images.

7. The method as recited in claim 2, where the olfactory sensory projector includes one or more reservoirs for holding scented liquids; or one or more impregnated fabrics capable of emitting scents when exposed to a voltage signal.

8. The method as recited in claim 2, where the tactile sensory projector includes one or more selectively movable elements; or one ore more selectable fabric types.

9. The method as recited in claim 1, further comprising:
selecting a format for the stored information from among a plurality of pre-determined formats; and
generating one or more output based on a portion of the stored information in the selected format.

10. The method as recited in claim 9, wherein the output comprises dynamically generated flash cards and utilization instructions for the flash cards.

11. The method as recited in claim 9, wherein the output is an individual progress report, a group progress report or a baby book.

12. The method as recited in claim 11, when said progress report is an individual progress report, the individual progress report includes comparative information; and when said progress report is a group progress report, the group progress report includes comparative information

13. The method as recited in claim 9, wherein the output includes supplemental information.

14. The method as recited in claim 13, wherein the supplemental information includes a video recording or a photographic image.

15. The method as recited in claim 1, where the selected exercises is implemented automatically or manually.

16. A system for implementing a prenatal and postnatal learning program, comprising:
a plurality of programmable sensory projectors for generating sensory information vectors;
a central control unit including hardware and software for generating a user interface and instructions for the plurality of sensory projectors in conjunction with a curriculum program;
a display device associated with the central control unit;
a storage means associated with the central control unit for storing the generated instructions, the stored curriculum program and information associated with plurality of programmable sensory projectors;
a printing device for generating supplemental information; and
means for exchanging information between the plurality of programmable sensory projectors and the central control unit.

17. The system as recited in claim 16, where the sensory projectors are selected from among an audio sensory projector, a visual sensory projector, an olfactory sensory projector and a tactile sensory projector.

18. The system as recited in claim 17, where the audio sensory projector is a prenatal audio player or an audio player.

19. The system as recited in claim 17, where the visual sensory projector comprises a visual display screen associated with a microprocessor.

20. The system as recited in claim 17, where the visual sensory projector comprises a static image holding device with elements for exposing and hiding static images.

21. The system as recited in claim 17, where the olfactory sensory projector includes one or more reservoirs for holding scented liquids; or one or more impregnated fabric capable of emitting scents when exposed to a voltage signal.

22. The system as recited in claim 17, wherein the tactile sensory projector includes one or more selectively movable elements; or one or more selectable fabric types.

23. The system as recited in 17, wherein the visual sensory projector can display three dimensional images or video images.

24. The system as recited in claim 17, wherein the sensory projector includes one or more feedback input elements.

25. The system as recited in claim 24, wherein the one or more feedback elements is selected from among a video camera, a microphone or a tactile feedback element.

26. The system as recited in claim 16, wherein the supplemental information comprises a set of flash cards.

27. The system as recited in claim 16, wherein the display device further includes a display element selected from among a flash card, a transparency, a computer display panel or a polymer dispersed liquid crystal.
